(19) United States
(12) Patent Application Publication
(10) Pub. No.: US 2019/0067964 A1
(43) Pub. Date: Feb. 28, 2019

(54) Multiple Fuse Device, and Method for Charging a Battery Using Said Multiple Fuse Device

(71) Applicant: Pacific Engineering Corporation, Ogaki-Shi (JP)

(72) Inventors: Fumiyuki Kawase, Ogaki-Shi (JP); Manabu Ota, Ogaki-Shi (JP)

(21) Appl. No.: 16/109,577

(22) Filed: Aug. 22, 2018

(30) Foreign Application Priority Data
Aug. 22, 2017 (JP) 2017-158998

(51) Int. Cl. H02J 7/00; H02B 1/20; H02B 1/48; H01R 25/16

(52) U.S. Cl. CPC H02J 7/0029; H02J 7/0042; H01R 25/168; H02B 1/48; H02B 1/20

(57) ABSTRACT

The present invention provides a multiple fuse device capable of charging a battery with a configuration simpler than the conventional art, and a method for charging a battery using the multiple fuse device. A multiple fuse device 400 includes a bus bar 100 including an input terminal 110, a plurality of external terminals 120, and fusible portions 113 provided between the input terminal 110 and the external terminals 120, and a housing 200 configured to cover the bus bar 100, wherein an opening 230 is provided in a part of the housing 200, and part of the bus bar 100 is exposed through the opening 230 in a state where the multiple fuse device 400 is mounted in a fuse box 700.

### CROSS-REFERENCE TO RELATED APPLICATIONS

This application claims priority to and the benefit of the filing of Japanese Patent Application No. 2017-158998, entitled “MULTIPLE FUSE DEVICE, AND METHOD FOR CHARGING A BATTERY USING SAID MULTIPLE FUSE DEVICE”, filed on Aug. 22, 2017, and the specification and claims thereof are incorporated herein by reference.

### STATEMENT REGARDING FEDERALLY SPONSORED RESEARCH OR DEVELOPMENT

Not Applicable.

### THE NAMES OF PARTIES TO A JOINT RESEARCH AGREEMENT

Not Applicable

### INCORPORATION BY REFERENCE OF MATERIAL SUBMITTED ON A COMPACT DISC

Not Applicable

### STATEMENT REGARDING PRIOR DISCLOSURES BY THE INVENTOR OR A JOINT INVENTOR

Not Applicable

### COPYRIGHTED MATERIAL

Not Applicable

### FIELD OF THE INVENTION

The present invention mainly relates to fuse devices used in electric circuits for automobiles, and particularly relates to a multiple fuse device including a plurality of external terminals, and a method for charging a battery using such a multiple fuse device.

### DESCRIPTION OF THE RELATED ART

Fuse devices have conventionally been used to protect electric circuits installed in automobiles and the like, as well as various electrical components connected to such circuits. Specifically, when an unintended overcurrent flows through an electric circuit, a fusible portion melts due to the heat generated by the overcurrent, protecting the corresponding electrical components from the inflow of excessive current.

Various kinds of fuse devices have been available in accordance with their applications. For example, Japanese Patent Application Publication No. 2015-022866 A discloses a multiple fuse device for use in a vehicle, the multiple fuse device establishing a connection between a battery and wires for supplying electric power to various electrical components. The multiple fuse device has a plurality of external terminals respectively coupled to the electrical components, and fusible portions interposed between the respective external terminals and the battery to protect the corresponding electrical components from the inflow of excessive current.

More specifically, as shown in FIG. 4A, opening the bonnet at the front of automobile 500, there is an engine room 510 housing a battery 600 and a fuse box 700. FIG. 4A is a magnified perspective view of the engine room 510 of the automobile 500, and FIG. 4B is a schematic view of the electrical connections of the components of the battery 600 and the fuse box 700.

In addition, a multiple fuse device 800 is inserted and mounted in the fuse box 700, and, as shown in FIG. 4B, the plus terminal 610 of the battery 600 is connected to the input terminal (not shown) of the multiple fuse device 800 through the wire X1, and the minus terminal 620 is connected to the automobile body 511 through the wire X2. Further, the positive terminal side of the electric circuit 900 is connected to the external terminals of the multiple fuse device 800 through the wire X3, and the negative terminal side of the electric circuit 900 is connected to the automobile body 511 through the wire X4. Being connected in this manner, the battery 600 can supply power to the electric circuit 900 through the multiple fuse device 800. Meanwhile, the fusible portions 810 of the multiple fuse device 800 are interposed between the battery 600 and the electric circuit 900, such that the electric circuit 900 can be protected from the inflow of an excessive current.

The battery 600 installed in the automobile 500 may run out due to various causes. In such a case, there is a need to prepare a battery 600RB (e.g. a battery installed on another automobile or the like) for charging the battery 600. Specifically, a wire Y2 is connected to the plus terminal 610RB of the battery 600RB and the charging connecting terminal Y1 at the end of the wire Y2 is connected to the plus terminal 610 of the battery 600. This plus terminal 610 is a component commonly known as a battery post, to which the clip-shaped connecting terminal Y1 can be clipped. Meanwhile, the minus terminal 620RB of the battery 600RB is connected to the automobile body 511 via a wire Y3. In this way, the plus terminal 610 and minus terminal 620 of the battery 600 are electrically connected respectively to the plus terminal 610RB and the minus terminal 620RB of the battery 600RB, and the battery 600 is thus charged by the battery 600RB.

With the introduction of hybrid and electric vehicles in recent years, automobiles are becoming more advanced and complex, and for reasons such as an increased number of devices to be housed in the engine room 510, it is sometimes not possible to fit the battery 600 inside the engine room 510. In such a case, the battery 600 is not housed within the engine room 510, but, as shown in FIG. 5B, at the rear of the automobile 500, for example underneath the floor of the trunk 520. FIG. 5A is a perspective view showing the engine room 510 of the automobile 500 in magnification, and FIG. 5B is a schematic view showing the electrical connections of the components of the battery 600 and the fuse box 700. As the electrical connections of the components shown in FIG. 5B are essentially the same as those shown in FIG. 4B, like components are denoted by like numerals herein, foregoing a detailed description thereof.

When charging the battery 600, however, the floor panel of the trunk 520 needs to be removed so that the connecting terminal Y1 can be attached to the plus terminal 610 of the battery 600, and this task is not easily done by the average user. An attachment member 710 to which the connecting terminal Y1 could be attached was therefore provided to fuse box 700, to enable a charging operation to be performed in the engine room 510 as usual. This attachment member 710 is electrically connected to the wire X1 by a wire X5, as shown in FIG. 5B. As such, by connecting the connecting terminal Y1 to the attachment member 710 as shown in FIG. 5A, the battery 600 is charged by the battery 600RB using the conventional method illustrated in FIG. 4.

However, there was a problem in that the attachment member 710 must be newly provided, and that the configuration of the fuse box 700 must be altered to allow for the attachment member 710 to be attached.

### PRIOR ART DOCUMENTS

The disclosure of Japanese Patent Application Publication No. 2015-22866 is incorporated by reference herein in its entirety.

### SUMMARY OF THE INVENTION

### Problem to be Solved by the Invention

To address the aforementioned problems, the present invention provides a multiple fuse device that enables charging of a battery with a simpler configuration than the conventional art, and a method for charging a battery using such a multiple fuse device.

### Means for Solving the Problem

The multiple fuse device according to an embodiment of the present invention includes a bus bar having an input terminal, a plurality of external terminals, and fusible portions provided between the input terminal and the external terminals, and a housing covering the bus bar. An opening is provided in a portion of the housing, so that when the multiple fuse device is mounted in the fuse box, a portion of the bus bar is exposed through the opening.

According to the aforementioned features, a simple configuration is employed in which a portion of the bus bar is exposed through the opening, which allows for charging of the battery using the exposed portion of the bus bar. As a result, there is no need to provide an attachment member and to alter the configuration of the fuse box to accommodate the attachment member as in the conventional art shown in FIG. 5.

The multiple fuse device according to an embodiment of the present invention includes a cover that opens and closes the opening.

According to the aforementioned feature, the cover may be opened when charging the battery, and may be closed at any other time when not charging, providing high safety.

The method for charging a battery according to an embodiment of the present invention includes the steps of mounting the aforementioned multiple fuse device in a fuse box connected to a battery, connecting a connecting terminal for charging to the bus bar exposed through the opening of the multiple fuse device, and charging the battery.

According to the aforementioned features, charging of a battery can be carried out easily.

### Effects of the Invention

As stated above, the multiple fuse device and the method for charging a battery using the multiple fuse device according to an embodiment of the present invention enable charging of a battery with a simpler configuration than the conventional art.

### BRIEF DESCRIPTION OF THE DRAWINGS

The accompanying drawings, which are incorporated into and form a part of the specification, illustrate one or more embodiments of the present invention and, together with the description, serve to explain the principles of the invention. The drawings are only for the purpose of illustrating one or more embodiments of the invention and are not to be construed as limiting the invention. In the drawings:

FIG. 1A is a perspective view of a multiple fuse device according to an embodiment of the present invention.

FIG. 1B is a front view of a bus bar.

FIG. 2A is a perspective view of the multiple fuse device according to an embodiment of the present invention in a disassembled state.

FIG. 2B is a perspective view of the multiple fuse device in an assembled state.

FIG. 2C is a perspective view of the multiple fuse device with a cover mounted thereto.

FIG. 3A is a perspective view of an engine room of an automobile in magnification.

FIG. 3B is a perspective view of an area around the multiple fuse device according to an embodiment of the present invention in magnification.

FIG. 3C is a schematic view of the electrical connections of the components of the battery and the fuse box according to an embodiment of the present invention.

FIG. 4A is a perspective view of an engine room of an automobile according to the conventional art in magnification.

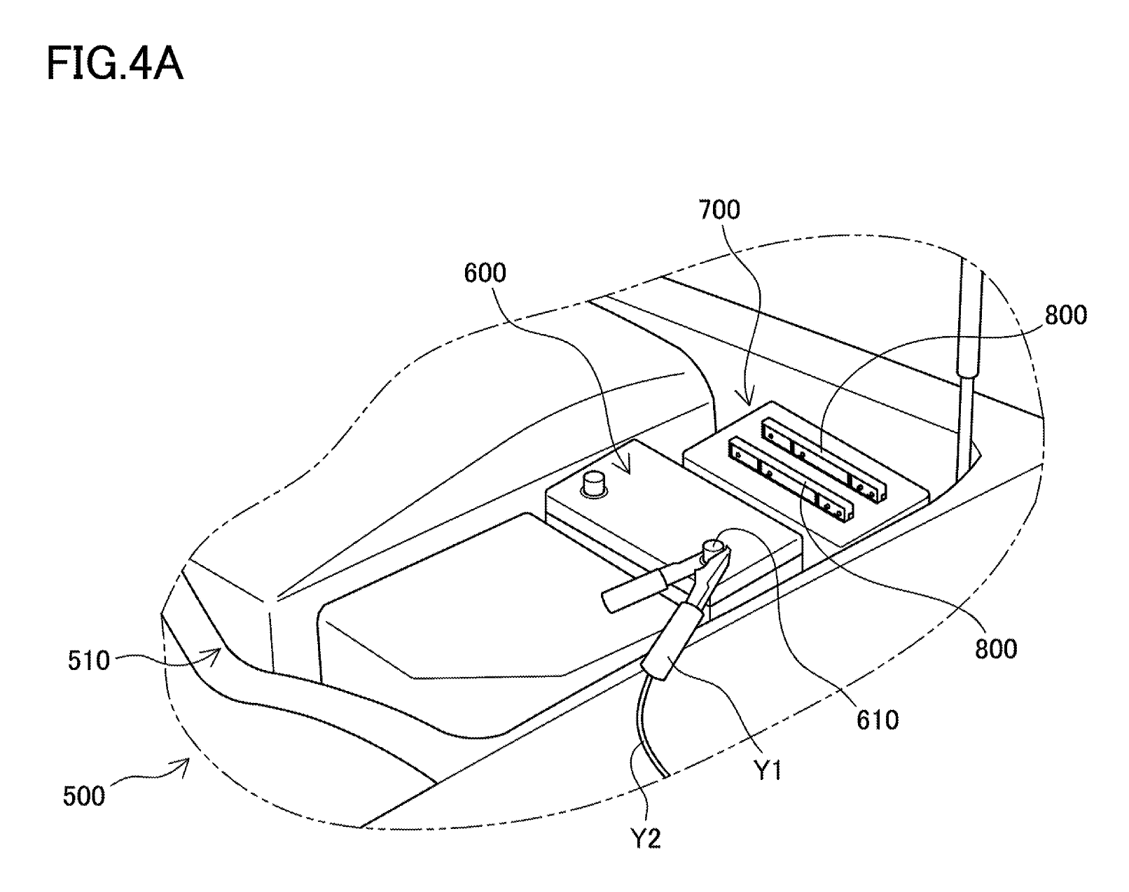

FIG. 4B is a schematic view of the electrical connections of the components of the battery and fuse box according to the conventional art.

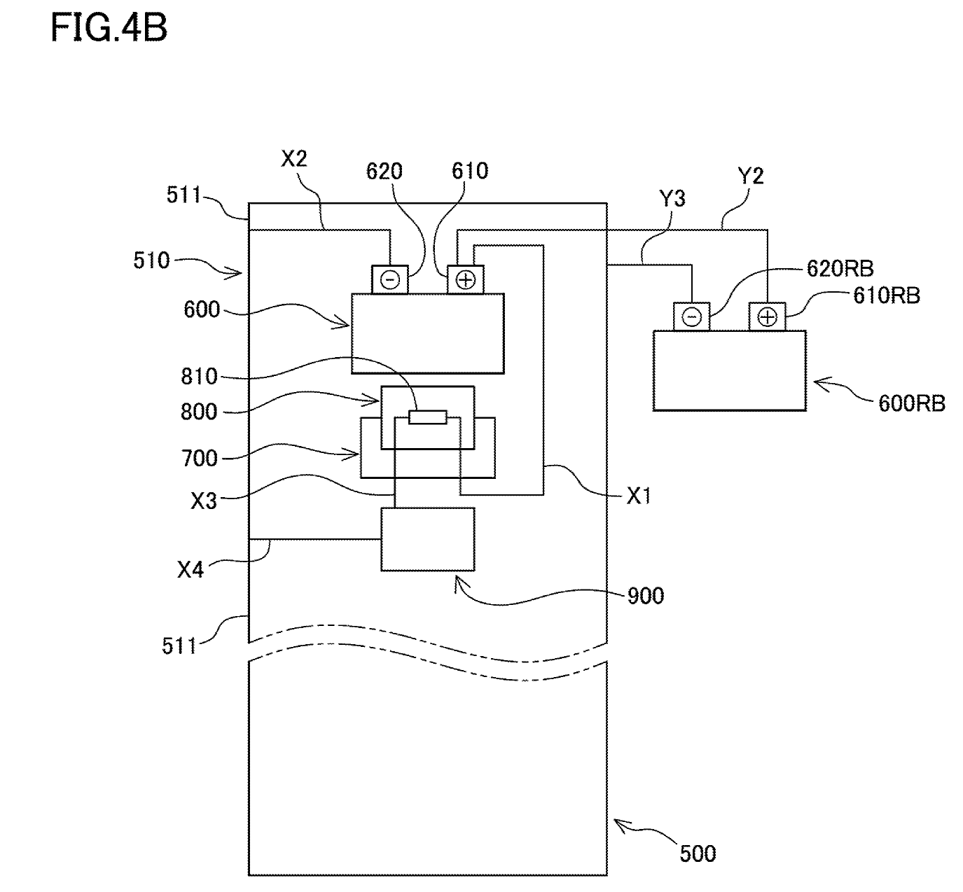

FIG. 5A is a perspective view of an engine room of an automobile according to the conventional art in magnification.

FIG. 5B is a schematic view of the electrical connections of the components of the battery and fuse box according to the conventional art.

### DESCRIPTION OF THE REFERENCE NUMERALS

100 bus bar
110 input terminal
113 fusible portion
120 external terminal
200 housing
230 opening
400 multiple fuse device

### DESCRIPTION OF THE EMBODIMENTS

An embodiment of the present invention is described below with reference to the drawings. It should be noted that the shapes, materials, etc. of the components of the multiple fuse device according to the embodiment described below are exemplary, and do not limit the scope of the invention.

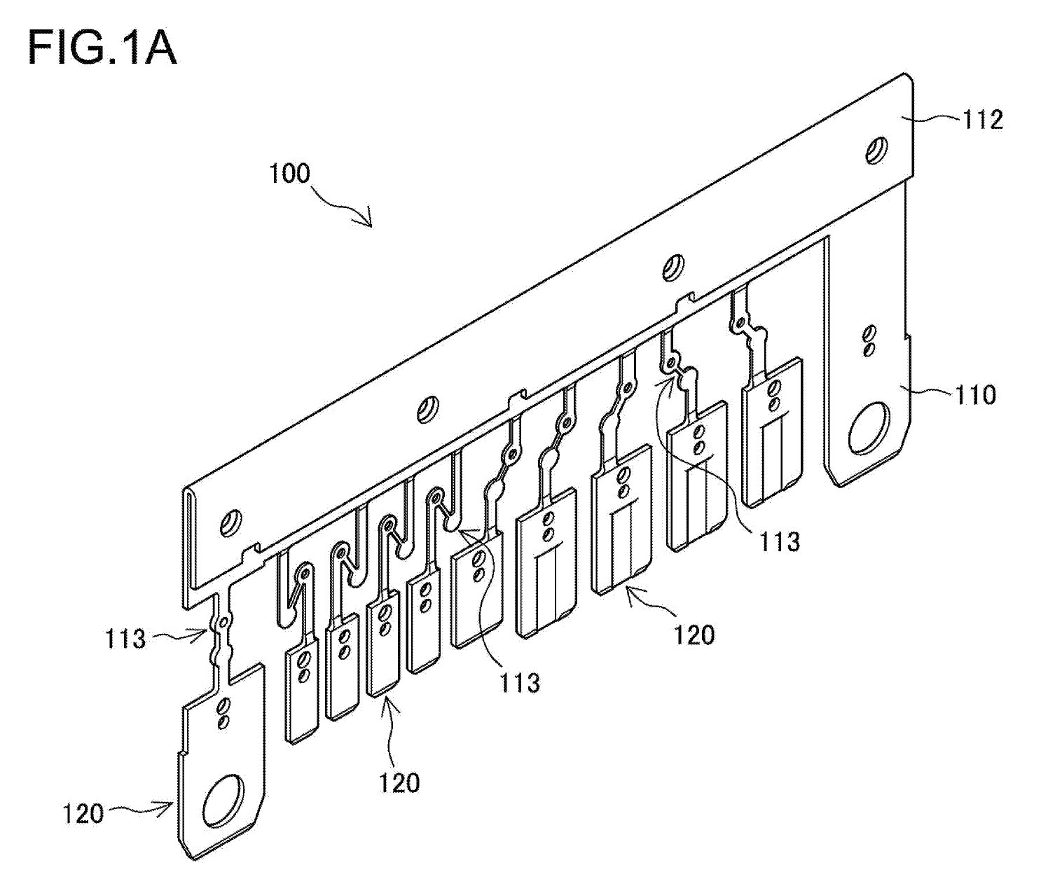

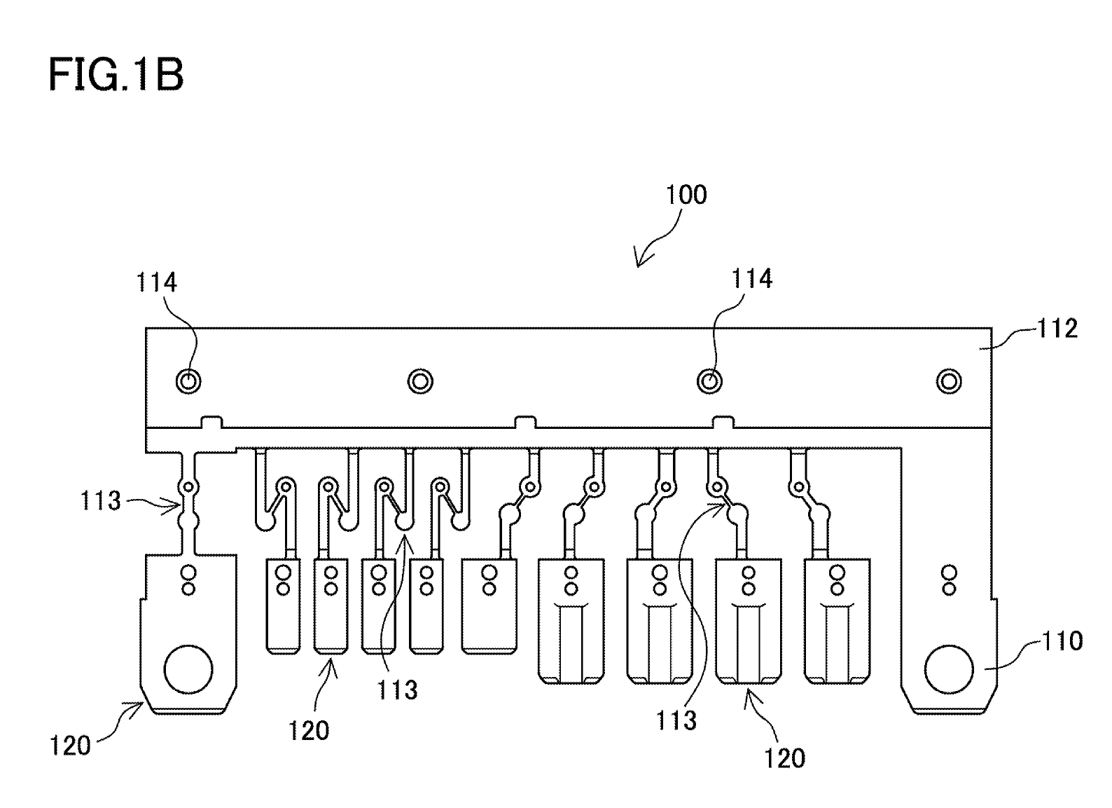

FIG. 1 shows a bus bar 100 of the multiple fuse according to the embodiment of the present invention. FIG. 1A is a perspective view of the bus bar 100, and FIG. 1B is a front view of the bus bar 100. The bus bar 100 is formed from a single, thin metal plate by integral molding using a die, and includes an input terminal 110 electrically connectable to, for example, a battery, and a plurality of external terminals 120. The input terminal 110 is coupled to a circuit portion 112, and the external terminals 120 are respectively coupled to the circuit portion 112 via fusible portions 113. Therefore, when overcurrent flows from a power supply such as the battery connected to the input terminal 110, the fusible portions 113 are cut to protect loads such as various electrical components coupled to the external terminals 120 from the inflow of excessive current.

Next, a brief description will be given of a method for molding the bus bar 100. First, a flat plate member having uniform thickness and made of a conductive metal such as copper or a copper alloy is die-cut into a predetermined shape, using a press machine or the like. Next, the upper edge of the bus bar 100 is folded over to form the circuit portion 112. The bus bar 100 illustrated in FIG. 1 is thus prepared.

Because the circuit portion 112 is formed by folding a part of the bus bar 100, the circuit portion 112 can be made thick. As described later, this makes it easier to clip the clip-shaped connecting terminal Y1 onto the circuit portion 112. Although the circuit portion 112 shown in FIG. 1 is formed by folding part of the bus bar 100, the circuit portion 112 is not limited to this configuration. After die-cutting the flat plate member having uniform thickness into a predetermined shape, using a press machine or the like, folding may be omitted to form the circuit portion 112 with the thickness as is. Further, the circuit portion 112, which connects the input terminal 110 and the external terminals 120, is not limited to the approximately rectangular configuration shown in FIG. 1, but can be made in any shape depending on the specifications.

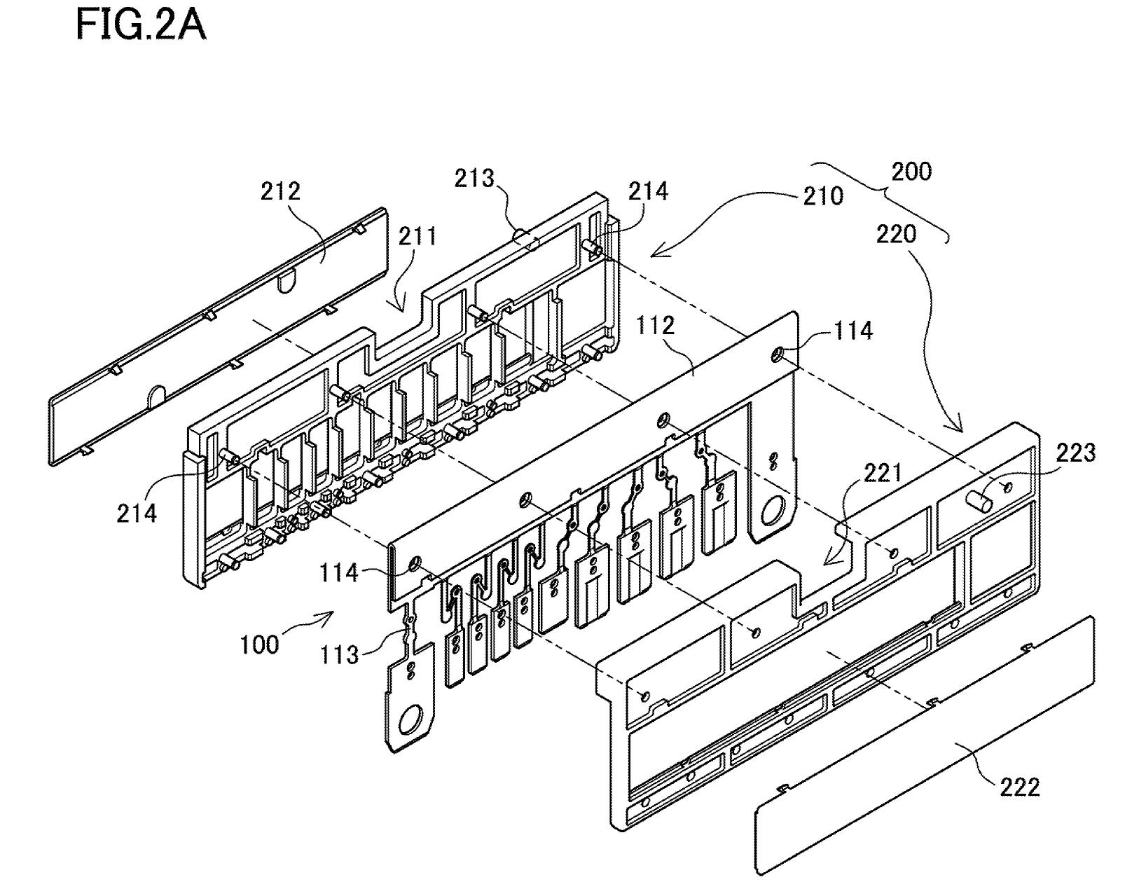

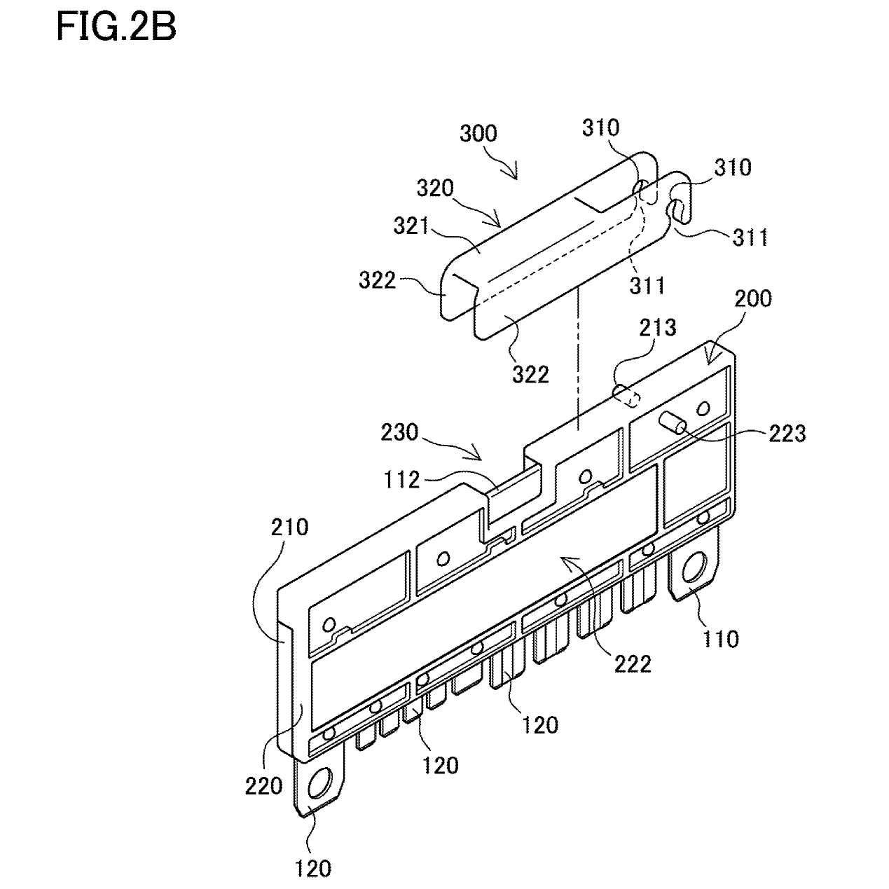

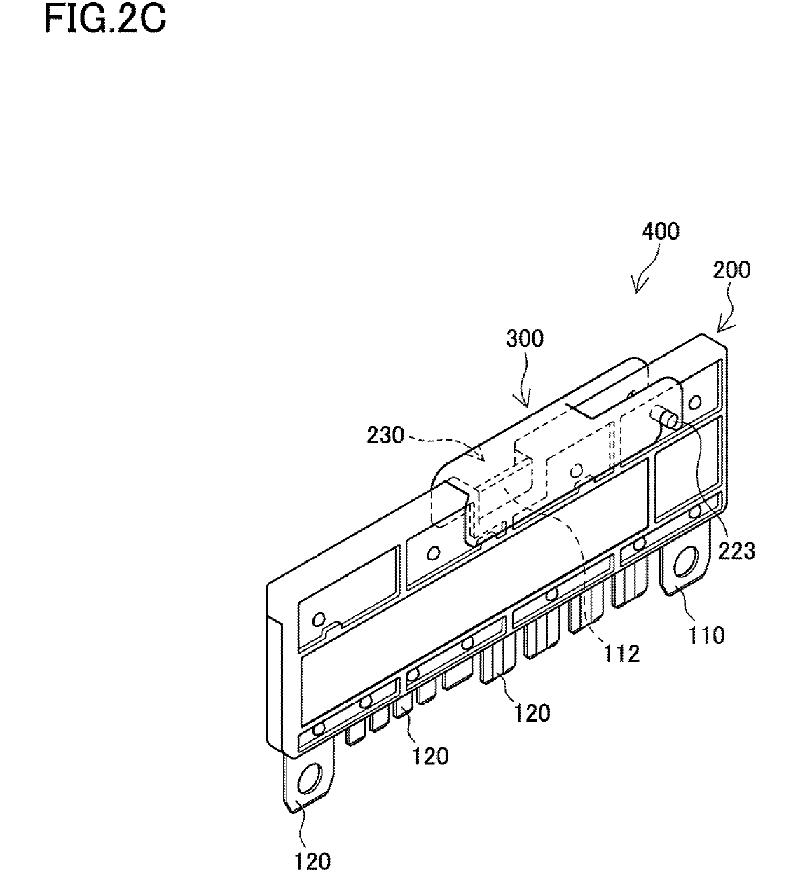

Referring now to FIG. 2, a description will be given of a way to assemble the multiple fuse device 400 according to the embodiment of the present invention. FIG. 2A is a perspective view of the multiple fuse device 400 in a disassembled state, FIG. 2B is a perspective view of the multiple fuse device 400 in an assembled state, and FIG. 2C is a perspective view of the multiple fuse device 400 with a cover 300 attached thereto.

First, as shown in FIG. 2A, a housing piece 210 is attached to the bus bar 100 by passing protrusions 214 of the housing piece 210 through holes 114 of the bus bar 100, and a housing piece 220 is attached by placing it over the bus bar 100 from above. As shown in FIG. 2B, the bus bar 100 is thus sandwiched between the housing pieces 210 and 220. These housing pieces 210 and 220 constitute the housing 200, and are made of an insulating synthetic resin or the like. In addition, a rotary axis 213 and a rotary axis 223 are formed protruding from the sides of the housing pieces 210 and 220, respectively.

In addition, a transparent window 212 is attached to the side of the housing piece 210, and a transparent window 222 is attached to the side of the housing piece 220. As these windows 212 and 222 are positioned on both sides of the fusible portions 113, they make the condition of the fusible portions 113 visible from the outside. These windows are also made of an insulating synthetic resin or the like.

Further, a notch 211 is formed in the upper edge of the housing piece 210, and in the upper edge of the housing piece 220 there is also formed a notch 221 in a position opposite the notch 211. When the housing pieces 210 and 220 are assembled, the notches 211 and 221 combine to form an opening 230. Part of the circuit portion 112 of the bus bar 100 sandwiched between the housing pieces 210 and 220 is exposed through the opening 230.

As shown in FIG. 2B, the cover 300 has mounting holes 310 on both sides, which are open to insertion ports 311 that extend vertically. The main body 320 of the cover 300 includes a top wall 321 and side walls 322 that extend downward from both edges of the top wall. The cover 300 is open at the bottom.

Therefore, as shown in FIG. 2B, when mounting the cover 300 to cover the opening 230, the rotary axes 213 and 223 are inserted into respective insertion ports 311 on both sides, and the cover 300 is pushed downward until the rotary axes 213 and 223 fit into the respective mounting holes 310. The main body 320 of the cover 300 is thus attached to the housing 200 so as to cover the area around the opening 230. The multiple fuse device 400 shown in FIG. 2C is thus prepared.

The cover 300 can rotate around the rotary axes 213 and 223, such that when the cover 300 is rotated upward, the opening 230 is opened, exposing the circuit portion 112 to the outside. When, on the contrary, the cover 300 is rotated downward, the opening 230 is closed, preventing exposure of the circuit portion 112 to the outside. As a result, the circuit portion 112 through which a high current flows can be protected from the outside.

The cover 300 is not an essential component, and in cases where there is no danger in having the circuit portion 112 of the bus bar 100 exposed in the engine room 510, the multiple fuse device 400 does not need to include the cover 300. Further, although the cover 300 is configured to rotate around the rotary axes 213 and 223, the cover 300 is not limited to this configuration. For example, an engaging claw may be provided on the cover 300 and an engaged portion on the housing 200, whereby the engaging claw of the cover 300 engages with the engaged portion on the housing 200 such that the cover 300 can be attached to and removed from the housing 200. Any other configuration may also be employed, so long as the cover 300 is of a shape capable of covering the opening 230, and the opening 230 can be opened and closed.

In addition, as shown in FIG. 2C, the input terminal 110 and the external terminals 120 protrude from the bottom edge of the housing 200 of the multiple fuse device 400. Thus, when the multiple fuse device 400 is inserted into the fuse box 700 as described later, the input terminal 110 and the external terminals 120 will be electrically connected to the respective wires (wire X1, wire X3).

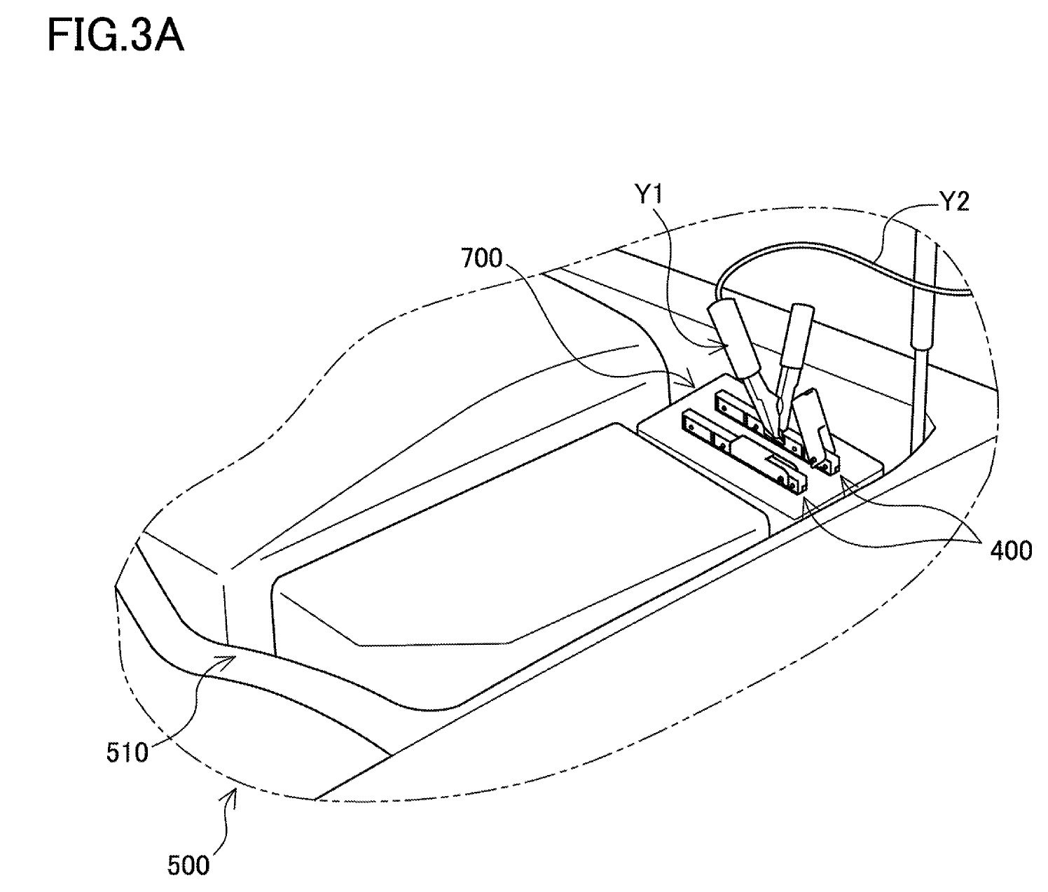

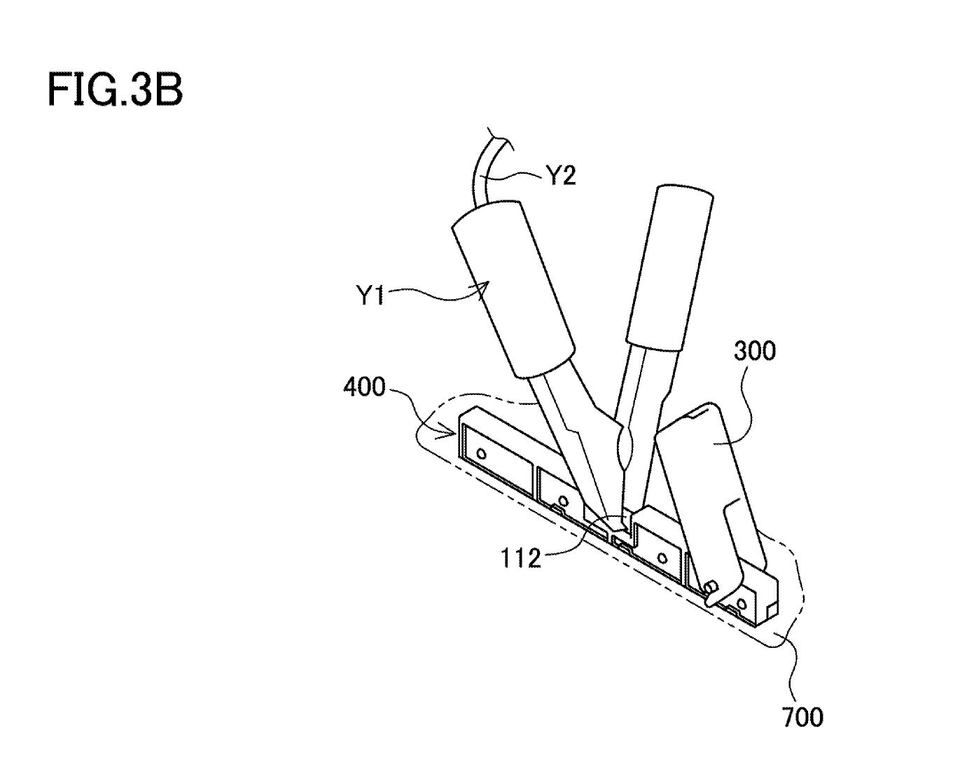

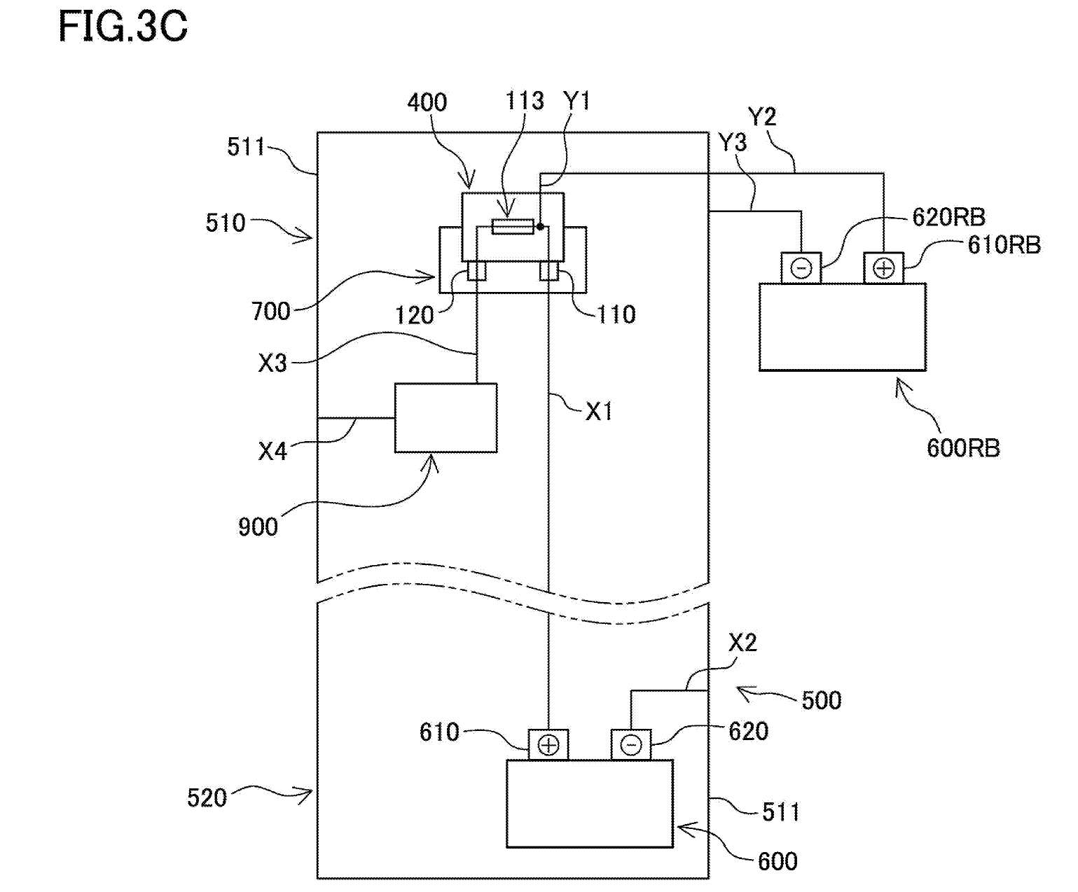

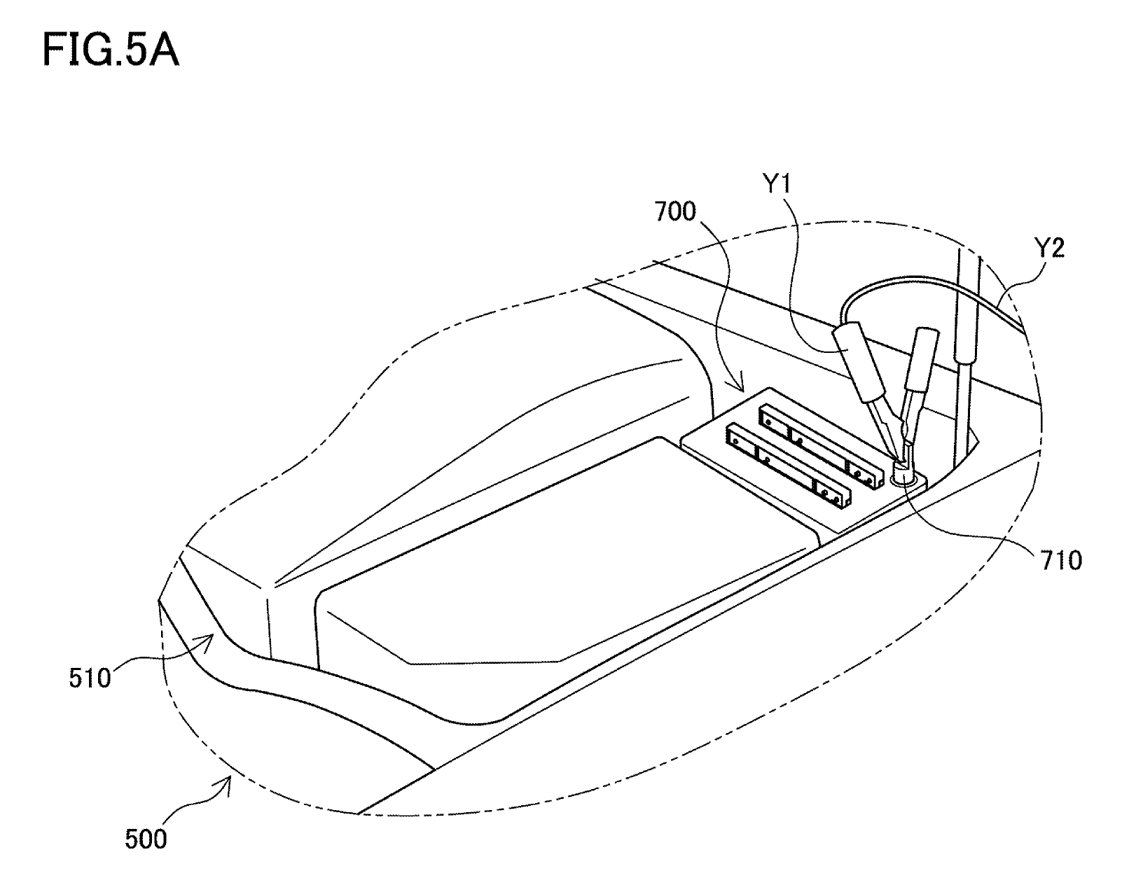

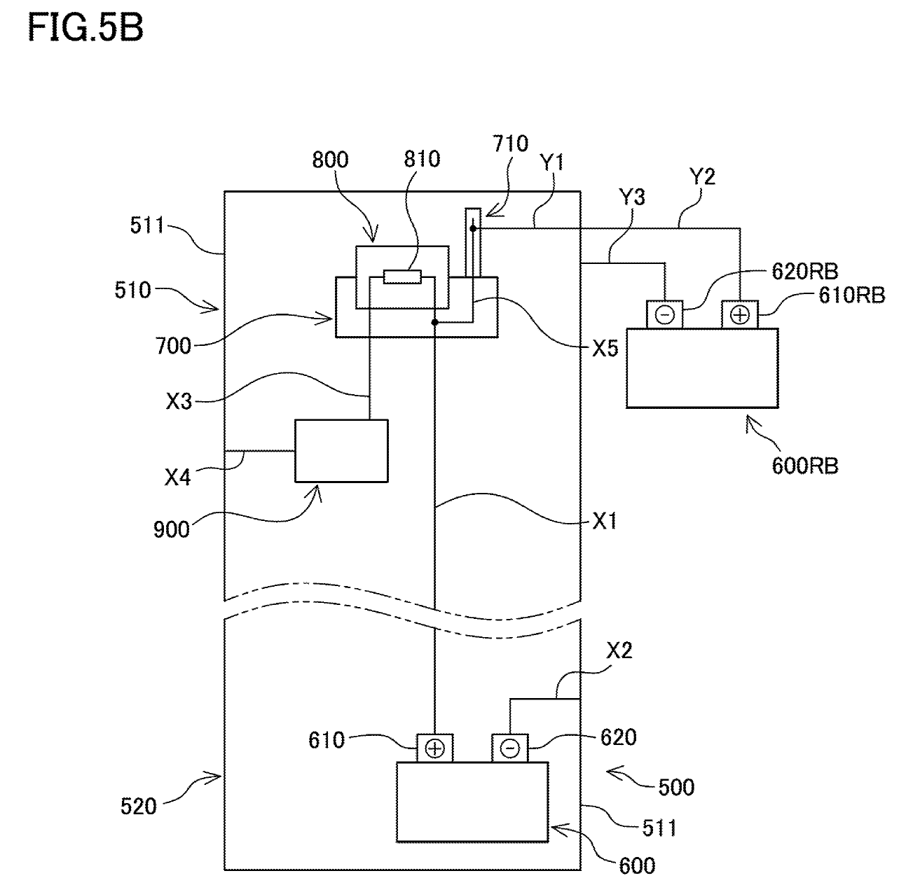

Referring next to FIG. 3, a description will be give of the method for charging a battery 600 using the multiple fuse device 400 according to the embodiment of the present invention. FIG. 3A is a perspective view showing an engine room 510 of an automobile 500 in magnification, FIG. 3B is a perspective view of an area around the multiple fuse device 400 in magnification, and FIG. 3C is a schematic view of the electrical connections of the components of the battery 600 and the fuse box 700. Further, the connections of the components shown in FIG. 3C are essentially identical to the connections of the components shown in FIG. 5C.

First, as shown in FIG. 3C, the multiple fuse device 400 according to the embodiment of the present invention is used to charge a battery 600 in a case where, for example, the battery 600 is not provided in the engine room 510 of the automobile 500, but housed under the floor of the trunk 520 at the rear of the automobile 500.

Specifically, as shown in FIG. 3A, opening the bonnet at the front of the automobile 500, the fuse box 700 is housed in the engine room 510. The multiple fuse device 400 according to the embodiment of the present invention is inserted and mounted in the fuse box 700. As shown in FIG. 3C, the plus terminal 610 of the battery 600 housed in the trunk 520 of the automobile 500 is connected to the input terminal 110 of the multiple fuse device 400 through the wire X1, and the minus terminal 620 is connected to the automobile body 511 through the wire X2. Further, the positive terminal side of the electric circuit 900 is connected to the external terminals 120 of the multiple fuse device 400 through the wire X3, and the negative terminal side of the electric circuit 900 is connected to the automobile body 511 through the wire X4. Being connected in this way, the battery 600 can supply power to the electric circuit 900 through the multiple fuse device 400. Meanwhile, the fusible portions 113 of the multiple fuse device 400 are interposed between the battery 600 and the electric circuit 900, whereby the electric circuit 900 can be protected from the inflow of an excessive current. Normally, the opening 230 is closed by the cover 300, so that the circuit portion 112 of the bus bar 100 is not exposed to the outside.

When the battery 600 has run out, a battery 600RB for charging (e.g. a battery installed in another automobile or the like) is prepared, and charging of the battery 600 is performed. Specifically, the cover 300 of the multiple fuse device 400 inserted into the fuse box 700 is opened to expose the circuit portion 112 of the bus bar 100 to the outside as shown in FIG. 3B. Next, the clip-shaped connecting terminal Y1 at the end of the wire Y2 is clipped onto the circuit portion 112. Thus, since the circuit portion 112 is connected to the input terminal 110, the plus terminal 610RB of the battery 600RB will be connected to the plus terminal 610 of the battery 600 through the wire Y2, the circuit portion 112, the input terminal 110, and the wire X1. Meanwhile, the minus terminal 620RB of the battery 600RB is connected to the automobile body 511 via a wire Y3. In this way, the plus terminal 610 and minus terminal 620 of the battery 600 are electrically connected respectively to the plus terminal 610RB and the minus terminal 620RB of the battery 600RB, and the battery 600 is thus charged by the battery 600RB.

In this way, the multiple fuse device 400 according to the embodiment of the present invention makes it possible to charge the battery 600 using the circuit portion 112 exposed to the outside through the opening 230. In other words, thanks to the simple configuration of providing the opening 230 to expose part of the bus bar 100, there is no need to install an attachment member 710 and alter the configuration of the fuse box 700 to allow installation of the attachment member 710 as in the conventional art shown in FIG. 5.

Further, the multiple fuse device 400 is very safe, as it includes the cover 300 for opening and closing the opening 230, making it possible to open the opening 230 when charging the battery 600 and to close the opening 230 when not charging.

The opening 230 is provided at the upper side of the housing 200. This is because when the multiple fuse device 400 is inserted and mounted in the fuse box 700, the upper side of the housing 200 is exposed through the fuse box 700. In other words, by providing the opening 230 at the upper edge of the housing 200, the circuit portion 112 can be exposed to the outside through the opening 230 with the multiple fuse device 400 inserted in the fuse box 700, making it easy to attach the connecting terminal Y1 to the circuit portion 112. The opening 230 is not limited to the upper edge of the housing 200, but may be provided at any location of the housing 200 so long as this location is exposed through the fuse box 700 when the multiple fuse device 400 is inserted and mounted in the fuse box 700.

In addition, although in FIGS. 1 to 3 the multiple fuse device 400 according to the embodiment of the present invention is used when charging the battery 600 in a case where the battery 600 is housed under the floor panels or the like of the trunk 520 at the rear of the automobile 500, the invention is not so limited. For example, in a case where the battery 600 is disposed in the engine room 510 but the connecting terminal Y1 for some reason cannot be connected to the plus terminal 610 of the battery 600, the connecting terminal Y1 can be attached to the circuit portion 112 of the multiple fuse device 400 to charge the battery 600. In other words, the connecting terminal Y1 may be connected to a part of the bus bar 100 of the multiple fuse device 400 according to the embodiment of the present invention to charge the battery 600 regardless of the position of the battery 600.

Further, although in FIGS. 1 to 3 the multiple fuse device 400 according to the embodiment of the present invention is mounted in a fuse box of an automobile, the invention is not so limited, and apart from automobiles it may also be mounted and used in equipment having a fuse box connected to a battery. In addition, although in FIGS. 1 to 3 the multiple fuse device 400 according to the embodiment of the present invention has a circuit portion 112 which is part of the bus bar 100 exposed through the opening 230, the invention is not so limited, and a portion of the bus bar 100 may be exposed through the opening 230 at any location so long as this location is a portion between the fusible portions 113 and the input terminal 110.

It should also be noted that the multiple fuse device according to the embodiment of the present invention is not limited to the examples described above, but that various modifications and combinations are possible within the scope of the claims and embodiments, and that such modifications and combinations are included in the scope of rights.

Note that in the specification and claims, “about” or “approximately” means within twenty percent (20%) of the numerical amount cited. All computer software disclosed herein may be embodied on any computer-readable medium (including combinations of mediums), including without limitation CD-ROMs, DVD-ROMs, hard drives (local or network storage device), USB keys, other removable drives, ROM, and firmware.

Although the invention has been described in detail with particular reference to these embodiments, other embodiments can achieve the same results. Variations and modifications of the present invention will be obvious to those skilled in the art and it is intended to cover in the appended claims all such modifications and equivalents. The entire disclosures of all references, applications, patents, and publications cited above are hereby incorporated by reference.

1. A multiple fuse device comprising:
a bus bar including an input terminal, a plurality of external terminals, and fusible portions provided between the input terminal and the external terminals; and
a housing configured to cover the bus bar; wherein
an opening is provided in a part of the housing, and part of the bus bar is exposed through the opening in a state where the multiple fuse device is mounted in a fuse box.

2. The multiple fuse device according to claim 1, comprising a cover configured to open and close the opening.

3. A method for charging a battery, the method comprising:
mounting the multiple fuse device according to claim 1 in a fuse box connected to a battery; and
connecting a connecting terminal for charging to a bus bar exposed through an opening of the multiple fuse device to charge the battery.

4. The method for charging a battery of claim 3, wherein the multiple fuse device comprises a cover configured to open and close the opening.
